(19) United States
(12) Patent Application Publication
(10) Pub. No.: US 2005/0170190 A1
(43) Pub. Date: Aug. 4, 2005

(54) Magnetic recording medium

(75) Inventors: Masahiko Mori, Kanagawa (JP); Hiroshi Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/046,877

(22) Filed: Feb. 1, 2005

(30) Foreign Application Priority Data
Feb. 2, 2004 (JP) 2004-025002
Feb. 18, 2004 (JP) 2004-040700

(51) Int. Cl. B32B 27/00

(52) U.S. Cl. 428/425.9

(57) ABSTRACT

A magnetic recording medium is provided that includes, above a non-magnetic support, at least one magnetic layer formed from a ferromagnetic powder dispersed in a binder, the magnetic recording medium including a first silane-modified polyurethane resin (Si-PU-I) obtained by a reaction between a polyurethane (a) having a hydroxyl group in the molecule and a hydrolyzable alkoxysilane (b), or a second silane-modified polyurethane resin (Si-PU-II) obtained by a reaction between the polyurethane (a) having a hydroxyl group in the molecule and an alkoxysilane (c) having an isocyanato group.

### BACKGROUND OF THE INVENTION

1. Field of the Invention

The present invention relates to a magnetic recording medium comprising at least one magnetic layer provided above a non-magnetic support, the magnetic layer being formed by dispersing a ferromagnetic powder and a binder.

2. Description of the Related Art

In general, with the demand for higher recording density of magnetic recording media for computer use, etc., it is necessary to yet further improve electromagnetic conversion characteristics, and it is important to make the ferromagnetic powder finer, the surface of the medium ultra smooth, etc.

With regard to finer magnetic substances, a recent magnetic substance employs a ferromagnetic metal powder of 0.1 μm or less or a fine ferromagnetic hexagonal ferrite powder having a plate size of 40 nm or less. In the case of a multilayer structure in which a magnetic layer is provided as an upper layer above a non-magnetic lower layer provided on the surface of a support, in order to highly disperse in a binder a fine non-magnetic powder used for the non-magnetic layer or the fine magnetic substance, a dispersion technique has been proposed in which the hydrophilic polar group —SO₃M (M denotes hydrogen, an alkali metal, or an ammonium salt) is introduced into the binder, and the binder chain is adsorbed on the magnetic substance or the non-magnetic powder via the polar group so as to achieve a smooth surface.

In the case of a binder into which a —SO₃ M group, etc. is introduced, if a binder having one SO₃M group per 10,000 to 20,000 units of molecular weight is used, for a binder having a low molecular weight of 5,000 to less than 10,000 there might be no SO₃ M present. Such a low molecular weight binder containing no SO₃ M does not contribute to adsorption onto and dispersion of a magnetic material, and is present on the surface of the magnetic layer, thus degrading the strength of the magnetic layer. In order to introduce a polar group into a low molecular weight binder, for example, an attempt has been made to introduce a large number of SO₃ M groups into a binder, but there is the problem that the solution viscosity increases and the dispersibility is instead degraded.

In order to improve the dispersibility, the use, as a resin for dispersing a magnetic material, of a mixture of a polyurea urethane and a polyurethane urea (meth)acrylate having a terminal trimethoxypropylsilane group has been proposed (ref. JP-A-6-195676 (JP-A denotes a Japanese unexamined patent application publication)). However, because the structure has a highly polar urea bond the solvent solubility is low, and a bonding reaction with the surface of the magnetic material cannot be expected to proceed sufficiently.

Furthermore, a process for producing a silane-modified polyurethane by a reaction between a polyurethane terminal OH group and a hydrolyzable alkoxysilane with removal of methanol has been disclosed (ref. JP-A-2000-327739). Although this silane-modified polyurethane is effective as an adhesive or a sealant, there is no example in which it is used in a magnetic recording medium, and its effectiveness is unknown.

### BRIEF SUMMARY OF THE INVENTION

It is an object of the present invention to provide a magnetic recording medium having excellent dispersibility, coating smoothness, and electromagnetic conversion characteristics, the magnetic recording medium also having excellent transport durability, and little scraping off of the surface of the magnetic layer or head contamination during repeated transport of a high recording density magnetic recording medium for a digital video tape recorder.

The object of the present invention has been attained by a magnetic recording medium comprising a first silane-modified polyurethane resin (Si-PU-I) obtained by a reaction between a polyurethane (a) having a hydroxyl group in the molecule and a hydrolyzable alkoxysilane (b), or a second silane-modified polyurethane resin (Si-PU-II) obtained by a reaction between the polyurethane (a) having a hydroxyl group in the molecule and an alkoxysilane (c) having an isocyanato group.

### DETAILED DESCRIPTION OF THE INVENTION

I. Binder

The magnetic recording medium of the present invention comprises a silane-modified polyurethane resin (Si-PU-I and/or Si-PU-II). The silane-modified polyurethane resin can be used in any coating layer provided in the magnetic recording medium. Among these coating layers, a magnetic layer, a non-magnetic layer, and a smoothing layer are representative; the silane-modified polyurethane resin can be used in any one of these layers or in a plurality thereof, and it is particularly preferable for it to be contained in the magnetic layer.

By using an alkoxysilyl group as a functional group introduced into a binder molecule, it is possible to prevent degradation in the dispersibility due to an increase in the solution viscosity. The alkoxy group of this alkoxysilyl group is easily hydrolyzed by, for example, a reaction between the alkoxy group and a hydroxyl group present on the surface of the magnetic material used in the magnetic layer. The polyurethane molecule is thus anchored to the surface of the magnetic material, the adsorption (bonding) of the polyurethane, which is a binder, increases, thus improving the dispersibility of the magnetic material and, moreover, low molecular weight components in the binder, which affect the strength of the surface of the magnetic layer, are also anchored to the surface of the magnetic material, thus giving a tough magnetic layer surface.

When an alkoxy group is introduced into a polyurethane molecule, the introduction is carried out by an addition reaction between a polyurethane (a) having a hydroxyl group in the molecule and a hydrolyzable alkoxysilane (b), or an addition reaction between the polyurethane (a) having a hydroxyl group in the molecule and an alkoxysilane (c) having an isocyanato group. With regard to the polyurethane of the present invention, by introducing a branched structure thereinto, at least three OH groups can be introduced per molecule, the amount of alkoxy group introduced by the above-mentioned addition reaction is increased, and it is therefore possible to increase the adsorption (bonding) of the polyurethane.

The silane-modified polyurethane resin used in the present invention is obtained by reaction of the hydrolyzable alkoxysilane (b) or the alkoxysilane (c) having an isocyanato group, with the polyurethane (a) having a hydroxyl group in the molecule, the polyurethane (a) being obtained by a reaction of a diol, a diisocyanate compound, and a polyol preferably having at least three hydroxyl groups in the molecule. The polyurethane (a) having a hydroxyl group in the molecule is obtained by a reaction in which the total amount of diol and polyol is in excess relative to the diisocyanate compound.

Polyurethane (a) Having a Hydroxyl Group in the Molecule

With regard to the diol and the isocyanate compound that are used as starting materials for the polyurethane resin of the present invention, long chain diols, short chain diols (also called chain extending agents), and diisocyanate compounds described in detail in the ‘Poriuretan Jushi Handobukku’ (Polyurethane Resin Handbook) (Ed. by K. Iwata, 1986, The Nikkan Kogyo Shimbun Ltd.) are used.

As the long chain diols, polyester diols, polyether diols, polyetherester diols, polycarbonate diols, polyolefin diols, etc. that have a molecular weight of 500 to 5,000, can be used. The polyurethane resin is called a polyester urethane, a polyether urethane, a polyetherester urethane, a polycarbonate urethane, etc. depending on the type of this long chain polyol.

The polyester diols are obtained by polycondensation of a glycol and an aliphatic dibasic acid such as adipic acid, sebacic acid, or azelaic acid or an aromatic dibasic acid such as isophthalic acid, orthophthalic acid, terephthalic acid, or naphthalenedicarboxylic acid.

Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol (neopentyl glycol), 1,8-octanediol, 1,9-nonanediol, cyclohexanediol, cyclohexanedimethanol, and hydrogenated bisphenol A.

As the polyester diol, it is also possible to use a polycaprolactonediol or a polyvalerolactonediol obtained by ring-opening polymerization of a lactone such as ε-caprolactone or γ-valerolactone. From the viewpoint of hydrolysis resistance, it is preferable to use, as the polyester diol, one having a branched side chain, or one obtained from an aromatic or alicyclic starting material.

Examples of the polyether diols include polyethylene glycol, polypropylene glycol, polytetramethylene glycol, and those obtained by addition polymerization of an alkylene oxide such as ethylene oxide or propylene oxide with an aromatic glycol such as bisphenol A, bisphenol S, bisphenol P, or hydrogenated bisphenol A, or an alicyclic diol.

These long chain diols may be used singly or in a combination of a plurality of diols.

The short chain diols can be selected from the same compounds as those cited as examples for the glycol component of the polyester diol.

Furthermore, in the present invention it is preferable to use a polyol having at least three hydroxyl groups in the molecule. Specific examples thereof include tri- or higher-functional polyhydric alcohols such as trimethylolethane, trimethylolpropane, and pentaerythritol. By the combined use of these polyhydric alcohols, a branched polyurethane resin can be obtained, and by decreasing the solution viscosity or increasing the number of terminal hydroxyl groups of the polyurethane, it is possible to enhance the curability with an isocyanate curing agent.

Specific examples of the diisocyanate compounds include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic or alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/diisocyanate composition of the polyurethane (a) having a hydroxyl group in the molecule is preferably (15 to 80 wt %)/(5 to 40 wt %)/(15 to 50 wt %).

Hydrolyzable Alkoxysilane (b)

The hydrolyzable alkoxysilane (b) referred to here means a hydrolyzable compound having at least one Si atom and at least two alkoxy groups bonded to this Si atom.

The hydrolyzable alkoxysilane (b) is preferably a tetraalkoxysilane and/or a condensate thereof represented by Formula (1) below.

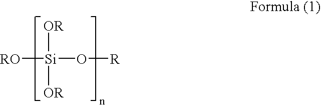

In Formula (1), R denotes a straight-chain or branched-chain lower alkyl group having six or fewer carbons. Two or more of R may be identical to or different from each other. Examples of the lower alkyl group having 1 to 6 carbons include a methyl group, an ethyl group, a propyl group, and a butyl group, and these alkyl groups may be open chain or branched. Among these lower alkyl groups, a methyl group and an ethyl group are preferable.

In Formula (1), n denotes an integer of 1 to 10, and preferably an integer of 1 to 5.

Specific examples of the tetraalkoxysilane represented by Formula (1) include tetramethoxysilane, tetraethoxysilane, tetra-n-propoxysilane, tetra-iso-propoxysilane, tetra-n-butoxysilane, tetra-sec-butoxysilane, and tetra-tert-butoxysilane. Among these, tetramethoxysilane is preferable.

Examples of the condensate of the tetraalkoxysilane represented by Formula (1) include polytetraethoxysilane and polytetramethoxysilane.

As commercial tetraalkoxysilanes, ethyl orthosilicate, high purity ethyl orthosilicate, high purity ethyl orthosilicate (EL), methyl orthosilicate, propyl silicate, butyl silicate, etc. manufactured by Tama Chemicals Co., Ltd. can be cited.

As commercial tetraalkoxysilane condensates, Silicate 40, Silicate 45, Silicate 48, M Silicate 51, etc. manufactured by Tama Chemicals Co., Ltd. can be cited.

Furthermore, the hydrolyzable alkoxysilane (b) is also preferably a trialkoxysilane, a dialkoxysilane, and/or a condensate thereof represented by Formula (2), or a mixture thereof.

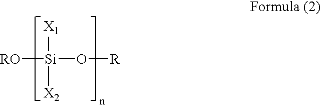

In the formula, X₁ denotes OR, a straight-chain or branched-chain lower alkyl group having six or fewer carbons, or a phenyl group, and X₂ denotes a straight-chain or branched-chain lower alkyl group having six or fewer carbons or a phenyl group. R denotes a straight-chain or branched-chain lower alkyl group having six or fewer carbons. Two or more of R may be identical to or different from each other. The straight-chain or branched-chain lower alkyl group having six or fewer carbons is the same as the lower alkyl group explained for Formula (1), and is preferably a methyl group or ethyl group. In Formula (2), n denotes an integer of 1 to 10, and preferably an integer of 1 to 5.

Specific examples of the trialkoxysilane represented by Formula (2) include methyltrimethoxysilane, methyltriethoxysilane, ethyltrimethoxysilane, ethyltriethoxysilane, methyltri-n-propoxysilane, ethyltri-n-propoxysilane, methyltri-iso-propoxysilane, ethyltri-iso-propoxysilane, methyltri-n-butoxysilane, ethyltri-n-butoxysilane, methyltri-sec-butoxysilane, ethyltri-sec-butoxysilane, methyltri-tert-butoxysilane, ethyltri-tert-butoxysilane, hexyltrimethoxysilane, hexyltriethoxysilane, phenyltrimethoxysilane, and phenyltriethoxysilane.

Specific examples of the dialkoxysilane represented by Formula (2) include dimethyldimethoxysilane, dimethyldiethoxysilane, dimethyldi-n-propoxysilane, diethyldi-n-propoxysilane, dimethyldi-iso-propoxysilane, diethyldi-iso-propoxysilane, dimethyldi-n-butoxysilane, diethyldi-n-butoxysilane, dimethyldi-sec-butoxysilane, diethyldi-sec-butoxysilane, dimethyldi-tert-butoxysilane, diethyldi-tert-butoxysilane, diphenyldimethoxysilane, and diphenyldiethoxysilane.

As commercial trialkoxysilanes and dialkoxysilanes, methyltrimethoxysilane (MTMS), methyltriethoxysilane (MTES), dimethyldimethoxysilane (DMDMS), dimethyldiethoxysilane (DMDES), etc. manufactured by Tama Chemicals Co., Ltd. can be cited.

Alkoxysilane (c) Having an Isocyanato Group

In the present invention, an alkoxysilane (c) having an isocyanato group (hereinafter, also called an ‘NCO group’) is used.

For the alkoxysilane (c) having an isocyanato group, a trialkoxysilane represented by Formula (3) below is preferable.
(R₁O)₃—Si—R₂—NCO Formula (3)

In Formula (3), R₁ denotes a straight-chain or branched-chain lower alkyl group having six or fewer carbons. Examples of the lower alkyl group having six or fewer carbons include a methyl group, an ethyl group, a propyl group, and a butyl group, and these alkyl groups may be open chain or branched. Among these lower alkyl groups, a methyl group and an ethyl group are preferable.

In Formula (3), R₂ denotes a lower alkylene group having six or fewer carbons. Specific examples of the lower alkylene group having six or fewer carbons include a methylene group, an ethylene group, a propylene group, a butylene group, a pentamethylene group, and a hexamethylene group. Among these, a propylene group is preferable.

Specific examples of the trialkoxysilane having an NCO group represented by Formula (3) include 3-isocyanato propyltrimethoxysilane and 3-isocyanato propyltriethoxysilane.

Commercial tetraalkoxysilanes having an NCO group include A-1310 and Y-5187 manufactured by Nippon Unicar Co., Ltd. and KBE9007 manufactured by Shin-Etsu Chemical Co., Ltd.

It is preferable to react 3 to 80 parts by weight of the hydrolyzable alkoxysilane (b) with 100 parts by weight of the polyurethane (a).

Furthermore, it is preferable to react 3 to 80 parts by weight of the alkoxysilane (c) having an isocyanato group with 100 parts by weight of the polyurethane (a).

The temperature of a silane modification reaction when synthesizing the silane-modified polyurethane (Si-PU-I, Si-PU-II) is not particularly limited, but the reaction temperature is preferably 70° C. to 150° C., and more preferably 80° C. to 130° C. The overall reaction time is preferably 2 to 15 hours.

A catalyst used in the reaction for the silane-modified polyurethane is preferably an organic acid, an organotin, or a tin salt of an organic acid. Among these, acetic acid and dibutyltin dilaurate are preferable.

In the silane modification reaction, it is not particularly necessary to use a solvent, and the reaction is usually carried out without any solvent, but it may be carried out in the presence of a solvent. The solvent used is not particularly limited as long as the polyurethane and alkoxysilane are soluble therein, but it is preferable to use an aprotic polar solvent having a boiling point of 75° C. or higher. Examples of this solvent include dimethylformamide (DMF), dimethylacetamide (DMAC), and methyl ethyl ketone (MEK).

The urethane group content of the silane-modified polyurethane resin is preferably 1 to 5 meq/g, and more preferably 1.5 to 4.5 meq/g.

It is preferable if the content is in such a range, since a high mechanical strength can be obtained and the dispersibility is improved due to good viscosity.

In order to improve the dispersibility of a magnetic powder or a non-magnetic powder, it is preferable for the silane-modified polyurethane resin to have a functional group (polar group) that is adsorbed on the surface of these powders. Preferred polar groups include —SO₃M, —SO₄M, —PO(OM)₂, —OPO(OM)₂, —COOM, >NSO₃M, —NR¹SO₃M, —NR¹R², and —N⁺R¹R²R³X⁻ (M denotes a hydrogen atom, an alkali metal, or an ammonium salt. R¹, R², and R³ denote a hydrogen atom or an alkyl group having 1 to 10 carbons, preferably having 1 to 5 carbons. X denotes a monovalent anion, and examples thereof include a halogen ion).

Among these, —SO₃M is particularly preferable since excellent dispersibility can be achieved. Two or more types of polar groups may be employed and, for example, —NR¹R² may be introduced as well as —SO₃M.

The polar group content is preferably 1×10⁻⁵ to 2×10⁻⁴ eq/g. It is preferable if the content is in this range, since sufficient adsorption on the magnetic powder can be achieved, the solvent solubility is good, and the dispersibility is improved.

The molecular weight of the binder is preferably 10,000 to 200,000 as a weight-average molecular weight, and more preferably 20,000 to 100,000. It is preferable if it is in such a range, since sufficient coating strength is obtained, the durability improves, and a stable dispersibility is obtained.

A resin other than the silane-modified polyurethane resin (Si-PU-I and Si-PU-II) may be used in combination as a binder.

With regard to a resin that can be used in combination with the silane-modified polyurethane resin, there can be cited as examples cellulose resins such as nitrocellulose, cellulose acetate, and cellulose propionate, polyvinyl alkylal resins such as polyvinyl acetal and polyvinyl butyral, acrylic resins, phenoxy resins, and polyester resins, which can be used in combination as part of the binder. It is preferable, from the viewpoint of the environment and suppression of corrosion of an MR head, not to use a vinyl chloride resin.

In order to increase the mechanical strength and heat resistance of a coating by crosslinking and curing the binder used in the present invention, it is possible to use a curing agent. A preferred curing agent is a polyisocyanate compound. The polyisocyanate compound used as the curing agent is preferably a tri- or higher-functional polyisocyanate. Specific examples thereof include adduct type polyisocyanate compounds such as a compound in which 3 moles of TDI (tolylene diisocyanate) are added to 1 mole of trimethylolpropane (TMP), a compound in which 3 moles of HDI (hexamethylene diisocyanate) are added to 1 mole of TMP, a compound in which 3 moles of IPDI (isophorone diisocyanate) are added to 1 mole of TMP, and a compound in which 3 moles of XDI (xylylene diisocyanate) are added to 1 mole of TMP. Furthermore, a condensed isocyanurate type trimer of TDI, a condensed isocyanurate type pentamer of TDI, a condensed isocyanurate heptamer of TDI, mixtures thereof, an isocyanurate type condensation product of HDI, an isocyanurate type condensation product of IPDI, and crude MDI can be cited as examples.

Among these, the compound in which 3 moles of TDI are added to 1 mole of TMP, and the isocyanurate type trimer of TDI are preferable.

Specifically, Coronate 3041 (manufactured by Nippon Polyurethane Industry Co., Ltd.) can be used preferably.

Other than the isocyanate-based curing agent, it is also possible to use a curing agent that is cured by radiation such as an electron beam or ultraviolet rays. In this case, a compound having, as a radiation-curable functional group, two or more, and preferably three or more, acryloyl groups or methacryloyl groups per molecule can be used suitably.

II. Magnetic Layer

The magnetic recording medium of the present invention has, above a non-magnetic support, at least one magnetic layer comprising a ferromagnetic powder dispersed in a binder. The resin used as a binder of the magnetic layer is not particularly limited, but it is preferable to use a polyurethane resin, and it is more preferable to use the above-mentioned silane-modified polyurethane resin (Si-PU-I and/or Si-PU-II).

The ferromagnetic powder used in the magnetic layer of the present invention can be either a ferromagnetic metal powder or a ferromagnetic hexagonal ferrite powder.

Ferromagnetic Metal Powder

The ferromagnetic metal powder used in the present invention is not particularly limited as long as Fe is contained as a main component (including an alloy), and a ferromagnetic alloy powder having α-Fe as a main component is preferable. These ferromagnetic metal powders may contain, apart from the designated atom, atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, and B. It is preferable for the powder to contain, in addition to α-Fe, at least one chosen from Al, Si, Ca, Y, Ba, La, Nd, Co, Ni, and B, and particularly preferably Co, Al, and Y. More specifically, the Co content is preferably 10 to 40 atom % relative to Fe, the Al content is preferably 2 to 20 atom %, and the Y content is preferably 1 to 15 atom %.

These ferromagnetic metal powders may be treated in advance, prior to dispersion, with a dispersant, a lubricant, a surfactant, an antistatic agent, etc., which will be described later. The ferromagnetic metal powder may contain a small amount of water, a hydroxide, or an oxide.

The water content of the ferromagnetic metal powder is preferably set at 0.01% to 2%. The water content of the ferromagnetic metal powder is preferably optimized according to the type of binder.

The crystallite size is preferably 8 to 20 nm, more preferably 9 to 18 nm, and particularly preferably 10 to 16 nm.

The crystallite size is an average value obtained by the Scherrer method from a half-value width of a diffraction peak obtained using an X-ray diffractometer (RINT2000 series, manufactured by Rigaku Corporation) with a CuKα1 radiation source, a tube voltage of 50 kV, and a tube current of 300 mA.

The length of the major axis of the ferromagnetic metal powder is preferably 10 to 80 nm, more preferably 25 to 75 nm, and yet more preferably 35 to 70 nm.

The specific surface area (hereinafter, S_{BET} means a specific surface area obtained by the BET method) of the ferromagnetic metal powder used in the magnetic layer of the present invention is preferably 30 to 80 m²/g, and more preferably 38 to 70 m²/g. This enables both good surface properties and low noise to be achieved at the same time.

The length of the major axis is determined by the combined use of a method in which a transmission electron microscope photograph is taken and the length of the minor axis and the length of the major axis of the ferromagnetic metal powder are measured directly therefrom, and a method in which a transmission electron microscope photograph is traced by an IBASSI image analyzer (manufactured by Carl Zeiss Inc.) and read off.

The pH of the ferromagnetic metal powder is preferably optimized according to the binder used in combination therewith. The pH is in the range of 4 to 12, and preferably from 7 to 10. The ferromagnetic metal powder may be subjected to a surface treatment with Al, Si, P, or an oxide thereof, if necessary. The amount thereof is usually 0.1 to 10 wt % relative to the ferromagnetic metal powder. The surface treatment can preferably suppress adsorption of a lubricant such as a fatty acid to 100 mg/m² or less. The ferromagnetic metal powder may contain soluble inorganic ions such as Na, Ca, Fe, Ni or Sr ions in some cases, and their presence at 200 ppm or less does not particularly affect the characteristics. Furthermore, the ferromagnetic metal powder used in the present invention preferably has few pores, and the level thereof is preferably 20 vol % or less, and more preferably 5 vol % or less.

The form of the ferromagnetic metal powder may be any of acicular, granular, rice-grain shaped, and tabular as long as the above-mentioned requirements for the particle size are satisfied, but it is particularly preferable to use an acicular ferromagnetic metal powder. In the case of the acicular ferromagnetic metal powder, the acicular ratio is preferably 4 to 12, and more preferably 5 to 12.

The coercive force (Hc) of the ferromagnetic metal powder is preferably 159 to 239 kA/m (2,000 to 3,000 Oe), and more preferably 167 to 231 kA/m (2,100 to 2,900 Oe). The saturation magnetic flux density is preferably 100 to 300 mT (1,000 to 3,000 G), and more preferably 160 to 280 mT (1,600 to 2,800 G). The saturation magnetization (as) is preferably 100 to 170 A·m²/kg (emu/g), and more preferably 100 to 160 A·m²/kg (emu/g).

The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle distribution of goethite, a technique of using monodispersed α-Fe₂O₃, and a technique of preventing sintering between particles, etc. in the ferromagnetic metal powder.

The ferromagnetic metal powder can be obtained by a known production method and the following methods can be cited. There are a method in which hydrated iron oxide or iron oxide, on which a sintering prevention treatment has been carried out, is reduced with a reducing gas such as hydrogen to give Fe or Fe—Co particles, a method involving reduction with a composite organic acid salt (mainly an oxalate) and a reducing gas such as hydrogen, a method involving thermolysis of a metal carbonyl compound, a method involving reduction by the addition of a reducing agent such as sodium borohydride, a hypophosphite, or hydrazine to an aqueous solution of a ferromagnetic metal, a method in which a fine powder is obtained by vaporizing a metal in an inert gas at low pressure, etc. The ferromagnetic metal powder thus obtained can be subjected to a known slow oxidation process. A method in which hydrated iron oxide or iron oxide is reduced with a reducing gas such as hydrogen, and an oxide film is formed on the surface thereof by controlling the time and the partial pressure and temperature of an oxygen-containing gas and an inert gas is preferable since there is little loss of magnetization.

Ferromagnetic Hexagonal Ferrite Powder

The average plate size of the ferromagnetic hexagonal ferrite powder is preferably 5 to 200 nm. When a magnetoresistive head is used for playback in order to increase the track density, the plate size is preferably 40 nm or smaller so as to reduce noise. If the plate size is in this range, stable magnetization can be expected without the influence of thermal fluctuations, the noise is low, and it is suitable for high density recording.

The tabular ratio (plate size/plate thickness) is preferably 1 to 15, and more preferably 1 to 7. If the tabular ratio is small, high packing in the magnetic layer can be obtained, which is preferable, but if it is too small, sufficient orientation cannot be achieved, and it is therefore preferably at least 1. Furthermore, when the tabular ratio is 15 or less, the noise resulting from inter-particle stacking can be suppressed. The S_{BET} of a powder having a particle size within this range is 10 to 200 m²/g. The specific surface area substantially coincides with the value obtained by calculation using the plate size and the plate thickness.

The plate size and plate thickness distributions are preferably as narrow as possible. Although it is difficult, the distribution can be expressed using a numerical value by randomly measuring 500 particles on a TEM photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the magnetic substance can be adjusted so as to be on the order of 39.8 to 398 kA/m (500 to 5,000 Oe). A higher Hc is advantageous for high-density recording, but it is restricted by the capacity of the recording head. In the present invention, the Hc of the ferromagnetic hexagonal ferrite powder is on the order of 143 to 238 kA/m (1,800 to 3,000 Oe), and preferably 159 to 223 kA/m (2,000 to 2,800 Oe). When the saturation magnetization of the head exceeds 1.4 T, it is preferably 159 kA/m (2,000 Oe) or higher. The Hc can be controlled by the particle size (plate size, plate thickness), the types and the amount of element included, the element substitution sites, the conditions used for the particle formation reaction, etc.

The saturation magnetization (σs) is preferably 40 to 80 A·m²/kg (emu/g). A higher as is preferable, but there is a tendency for it to become lower when the particles become finer. In order to improve the saturation magnetization (σs), making a composite of magnetoplumbite ferrite with spinel ferrite, selecting the types of element included and their amount, etc., are well known. It is also possible to use a W type hexagonal ferrite.

When dispersing the ferromagnetic hexagonal ferrite powder, the surface of the ferromagnetic hexagonal ferrite powder can be treated with a material that is compatible with a dispersing medium and a polymer.

With regard to a surface-treatment agent, an inorganic or organic compound can be used. Representative examples include compounds of Si, Al, P, etc., and various types of silane coupling agents and various types of titanate coupling agents. The amount of the surface-treatment agent added is 0.1% to 10% relative to the ferromagnetic hexagonal ferrite powder. The pH of the ferromagnetic hexagonal ferrite powder is also important for dispersion. It is usually on the order of 4 to 12, and although the optimum value depends on the dispersing medium and the polymer, it is selected from on the order of 6 to 11 from the viewpoints of chemical stability and storage properties of the medium. The moisture contained in the ferromagnetic hexagonal ferrite powder also influences the dispersion. Although the optimum value depends on the dispersing medium and the polymer, it is usually 0.01% to 2.0%.

With regard to a production method for the ferromagnetic hexagonal ferrite powder, there is
glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed, and ground to give a barium ferrite crystal powder;
hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder;
co-precipitation method (3) in which a barium ferrite composition metal salt solution is neutralized with an alkali, and after a by-product is removed, it is dried and treated at 1100° C. or less, and ground to give a barium ferrite crystal powder, etc., but any production method can be used in the present invention.

The magnetic layer of the present invention can contain as necessary carbon black.

Types of carbon black that can be used include furnace black for rubber, thermal black for rubber, black for coloring, and acetylene black. The carbon black used in a magnetic layer should have characteristics that have been optimized as follows according to a desired effect, and the effect can be obtained by the combined use thereof.

The specific surface area of the carbon black is preferably 100 to 500 m²/g, and more preferably 150 to 400 m²/g. The dibutyl phthalate (DBP) oil absorption thereof (hereinafter ‘DBP oil absorption’ means oil absorption using dibutyl phthalate) is 20 to 400 mL/100 g, and preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, MA600, MA-230, #4000 and #4010 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo).

The carbon black may be subjected to any of a surface treatment with a dispersant, etc., grafting with a resin, or a partial surface graphitization. The carbon black may also be dispersed in a binder prior to addition to a coating solution. The carbon black that can be used in the present invention can be chosen from, for example, those described in the ‘Kabon Burakku Handobukku (Carbon Black Handbook)’ (edited by the Carbon Black Association of Japan, 1995).

The carbon black may be used singly or in a combination of different types thereof. The carbon black is preferably used in an amount of 0.1 to 30 wt % based on the weight of the magnetic substance. The carbon black has the functions of preventing static charging of the magnetic layer, reducing the coefficient of friction, imparting light-shielding properties, and improving the film strength. Such functions vary depending upon the type of carbon black. Accordingly, it is of course possible in the present invention to appropriately choose the type, the amount and the combination of carbon black for the magnetic layer according to the intended purpose on the basis of the above mentioned various properties such as the particle size, the oil absorption, the electrical conductivity, and the pH value, and it is better if they are optimized for the respective layers.

III. Non-Magnetic Layer

The magnetic recording medium of the present invention may have a non-magnetic layer comprising a binder and a non-magnetic powder between a non-magnetic support and the magnetic layer. Hereinafter, the non-magnetic layer is also called a ‘lower layer’.

A resin used as a binder of the non-magnetic layer is not particularly limited, but it is preferable to use a polyurethane resin, and it is possible to use the above-mentioned silane-modified polyurethane resin (Si-PU-I and/or Si-PU-II) singly or in a combination with an unmodified polyurethane resin.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide. Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, βalumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-iron oxide or a titanium oxide is preferable.

The form of the non-magnetic powder may be any one of acicular, spherical, polyhedral, and tabular. The crystallite size of the non-magnetic powder is preferably 0.004 to 1 μm, and more preferably 0.04 to 0.1 μm. It is preferable if it is in such a range, since good dispersibility and a smooth surface can be obtained.

The average particle size of these non-magnetic powders is preferably 0.005 to 2 μm, and more preferably 0.01 to 0.2 μm. It is also possible to combine non-magnetic powders having different average particle sizes as necessary, or widen the particle size distribution of a single non-magnetic powder, thus producing the same effect. It is preferable if it is in such a range, since good dispersibility and a smooth surface can be obtained.

The S_{BET} of the non-magnetic powder is preferably 1 to 100 m²/g, more preferably 5 to 70 m²/g, and yet more preferably 10 to 65 m²/g. When the specific surface area is in the above range, suitable surface roughness can be obtained, and dispersion can be carried out using a desired amount of binder.

The DBP oil absorption is preferably 5 to 100 mL/100 g, more preferably 10 to 80 mL/100 g, and yet more preferably 20 to 60 mL/100 g.

The specific gravity is preferably 1 to 12, and more preferably 3 to 6.

The tap density is 0.05 to 2 g/mL, and preferably 0.2 to 1.5 g/mL. It is preferable if the tap density is in the range of 0.05 to 2 g/mL, since there is little scattering of particles, the operation is easy, and it is possible to prevent the particles from sticking to equipment.

The pH of the non-magnetic powder is preferably 2 to 11, and particularly preferably 6 to 9. When the pH is less than 2, the coefficient of friction at high temperature and high humidity tends to increase. When the pH exceeds 11, the amount of free fatty acid decreases, and the coefficient of friction tends to increase.

The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. When the Mohs hardness is less than 4, it tends to be difficult to be able to guarantee durability.

The amount of stearic acid absorbed by the non-magnetic powder is preferably 1 to 20 μmol/m², and more preferably 2 to 15 μmol/m^{2.}

The heat of wetting of the non-magnetic powder in water at 25° C. is preferably in the range of 20 to 60 μJ/cm² (200 to 600 erg/cm²). It is possible to use a solvent that gives a heat of wetting in this range. The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer of the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, SN-100, MJ-7, α-iron oxide E270, E271, and E300 (manufactured by Ishihara Sangyo Kaisha Ltd.), STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO2P25 (manufactured by Nippon Aerosil Co., Ltd.), and 100A and 500A (manufactured by Ube Industries, Ltd.), Y-LOP (manufactured by Titan Kogyo Kabushiki Kaisha), and calcined products thereof. Particularly preferred non-magnetic powders are titanium dioxide and α-iron oxide.

By mixing carbon black with the non-magnetic powder, the surface electrical resistance (Rs) of the non-magnetic layer can be reduced, the light transmittance can be decreased, and a desired micro Vickers hardness can be obtained.

The micro Vickers hardness of the non-magnetic layer is usually 25 to 60 kg/mm², and is preferably 30 to 50 kg/mm² in order to adjust the head contact. The micro Vickers hardness can be measured using a thin film hardness meter (HMA-400 manufactured by NEC Corporation) with, as an indentor tip, a triangular pyramidal diamond needle having a tip angle of 80° and a tip radius of 0.1 μm.

The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer of the present invention is preferably 100 to 500 m²/g, and more preferably 150 to 400 m²/g, and the DBP oil absorption thereof is preferably 20 to 400 mL/100 g, and more preferably 30 to 200 mL/100 g. The average particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo).

The carbon black may be surface treated using a dispersant or grafted with a resin, or part of the surface thereof may be converted into graphite. Prior to adding carbon black to a coating solution, the carbon black may be predispersed with a binder. The carbon black can be used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Binran’ (Carbon Black Handbook) (edited by the Carbon Black Association of Japan).

It is also possible to add an organic powder to the non-magnetic layer, depending on the intended purpose. Examples thereof include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used.

IV. Other additives

In the magnetic recording medium of the present invention, additives for imparting a dispersion effect, lubrication effect, antistatic effect, plasticizing effect, etc. may be included in the magnetic layer or the non-magnetic layer.

Examples of these additives are as follows.

Molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof.

Aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof.

Alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, linolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid or a sulfate ester group; and an amphoteric surfactant such as an amino acid, an aminosulfonic acid, a sulfate ester, or a phosphate ester of an amino alcohol, or an alkylbetaine. Details of these surfactants are described in ‘Kaimenkasseizai Binran’ (Surfactant Handbook) (published by Sangyo Tosho Publishing). These lubricants, antistatic agents, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd); Enujelv OL (produced by New Japan Chemical Co., Ltd.); TA-3 (produced by Shin-Etsu Chemical Industry Co., Ltd.); Armide P (produced by Lion Armour); Duomin TDO (produced by Lion Corporation); BA-41G (produced by The Nisshin Oil Mills, Ltd.); and Profan 2012E, Newpol PE 61, and Ionet MS-400 (produced by Sanyo Chemical Industries, Ltd.).

The type and the amount of the dispersant, lubricant, and surfactant used in the present invention can be changed as necessary in the non-magnetic layer and the magnetic layer. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, and once adsorbed it is hard to desorb an organophosphorus compound from the surface of a metal, a metal compound, etc. Therefore, since in the present invention the surface of the ferromagnetic powder or the surface of the non-magnetic powder are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer.

All or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

An organic solvent used for the magnetic layer or the non-magnetic layer of the present invention can be a known organic solvent. As the organic solvent, a cyclic ether such as tetrahydrofuran, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, cresol, or chlorobenzene, a chlorohydrocarbon such as methylene chloride, ethylene chloride, carbon tetrachloride, chloroform, ethylene chlorohydrin, or dichlorobenzene, N,N-dimethylformamide, hexane, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and the non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

V. Non-Magnetic Support

In the magnetic recording medium of the present invention, the non-magnetic layer or the magnetic layer is formed by coating a non-magnetic support with a coating solution prepared using the above-mentioned materials.

With regard to the non-magnetic support that can be used in the present invention, known biaxially stretched films such as polyethylene naphthalate, polyethylene terephthalate, polyamide, polyimide, polyamideimide, aromatic polyamide, and polybenzoxazole can be used. Polyethylene naphthalate and aromatic polyamide are preferred. These non-magnetic supports can be subjected in advance to a corona discharge treatment, a plasma treatment, a treatment for enhancing adhesion, a thermal treatment, etc.

The non-magnetic support that can be used in the present invention preferably has a surface having excellent smoothness such that its center line average surface roughness is in the range of 0.1 to 20 nm, and preferably 1 to 10 nm, for a cutoff value of 0.25 mm. Furthermore, these non-magnetic supports preferably have not only a small center line average surface roughness but also no coarse projections with a height of 1 μm or greater.

The arithmetic average roughness (Ra) of the treated non-magnetic support is preferably 0.1 μm or less (JIS B0660-1998, ISO 4287-1997) since a magnetic recording medium obtained therefrom has a low level of noise.

A preferred thickness of the non-magnetic support of the magnetic recording medium of the present invention is 3 to 80 μm.

VI. Backcoat Layer

A backcoat layer (backing layer) may be provided on the side of the non-magnetic support used in the present invention that is not coated with a magnetic coating solution. The backcoat layer is a layer provided by applying, on the side of the non-magnetic support that is not coated with the magnetic coating solution, a backcoat layer-forming coating solution in which particulate components such as an abrasive or an antistatic agent and a binder are dispersed in an organic solvent. As the particulate components, various inorganic pigments or carbon black can be used, and as the binder, resins such as nitrocellulose, a phenoxy resin, or polyurethane can be used singly or as a mixture thereof. An adhesive layer may be provided on the side of the non-magnetic support of the present invention that is coated with the magnetic coating solution or the backcoat layer-forming coating solution.

VII. Undercoat Layer

In the magnetic recording medium of the present invention, an undercoat layer can be provided. Providing the undercoat layer enables the adhesion between the support and the magnetic layer or the non-magnetic layer to be improved. A solvent-soluble polyester resin can be used in the undercoat layer. The thickness of the undercoat layer is 0.5 μm or less.

VIII. Smoothing Layer

The magnetic recording medium of the present invention may be provided with a smoothing layer. The smoothing layer referred to here is a layer for burying projections on the surface of the non-magnetic support; it is provided between the non-magnetic support and the magnetic layer when the magnetic recording medium is provided with the magnetic layer on the non-magnetic support, and it is provided between the non-magnetic support and the non-magnetic layer when the magnetic recording medium is provided with the non-magnetic layer and the magnetic layer in that order on the non-magnetic support.

The smoothing layer can be formed by curing a radiation curable compound by exposure to radiation. The radiation curable compound referred to here is a compound having the property of polymerizing or crosslinking when irradiated with radiation such as ultraviolet rays or an electron beam, thus increasing the molecular weight and carrying out curing.

IX. Production Method

A process for producing a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages. All materials, including the ferromagnetic powder (the ferromagnetic hexagonal ferrite powder, the ferromagnetic metal powder), the non-magnetic powder, the binder, the carbon black, the abrasive, the antistatic agent, the lubricant, and the solvent used in the present invention may be added in any step from the beginning or during the course of the step. The addition of each material may be divided across two or more steps.

In the process for producing the magnetic recording medium of the present invention, when preparing the magnetic coating solution, which is a coating solution for the magnetic layer, at least one magnetic coating solution is prepared in which a ferromagnetic powder is dispersed in a binder solution. It is preferable to use the silane-modified polyurethane resin as the binder. When preparing this magnetic coating solution, a kneading step is employed in which the ferromagnetic powder and the silane-modified polyurethane resin, as all or part of the binder for the magnetic layer, are kneaded. In the kneading step, it is preferable to use a conventionally known powerful kneading machine such as an open kneader, a continuous kneader, a pressure kneader, or an extruder. When such a kneader is used, all or part of the binder (preferably 30 wt % or more of the entire binder) is preferably kneaded with the ferromagnetic powder. The proportion of the binder added is preferably 10 to 500 parts by weight relative to 100 parts by weight of the ferromagnetic powder. Details of these kneading treatments are described in JP-A-1-106338 and JP-A-1-79274.

A dispersing step is carried out subsequent to the kneading step. A coating solvent is added to the mixture of the ferromagnetic powder and the binder obtained in the kneading step, and the ferromagnetic powder is completely dispersed in the binder solution using a sand mill, etc. In order to disperse the magnetic layer coating solution or a non-magnetic layer coating solution, glass beads can be used. As such glass beads, a dispersing medium having a high specific gravity such as zirconia beads, titania beads, or steel beads is suitably used. An optimal particle size and packing ratio of these dispersing media is used. A known disperser such as a sand mill can be used.

With regard to a method for coating the non-magnetic support with the magnetic coating solution, for example, the surface of a moving non-magnetic support is coated with a magnetic layer coating solution so as to give a predetermined coating thickness. A plurality of magnetic layer coating solutions can be applied successively or simultaneously in multilayer coating, and a non-magnetic layer coating solution and a magnetic layer coating solution can also be applied successively or simultaneously in multilayer coating. As coating equipment for applying the above-mentioned magnetic coating solution or the lower layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used.

With regard to these, for example, ‘Saishin Kotingu Gijutsu’ (Latest Coating Technology) (May 31, 1983) published by Sogo Gijutsu Center can be referred to. As examples of the coating equipment and the coating method for the magnetic recording medium of the present invention, the following can be proposed.

(1) A lower layer is firstly applied by coating equipment such as gravure, roll, blade, or extrusion coating equipment, which is generally used for coating with a magnetic coating solution, and before the lower layer has dried an upper layer is applied by a pressurized support type extrusion coating device such as one disclosed in JP-B-1-46186, JP-A-60-238179, or JP-A-2-265672 (JP-B denotes a Japanese examined patent application publication).

(2) Upper and lower layers are substantially simultaneously applied by means of one coating head having two slits for a coating solution to pass through, such as one disclosed in JP-A-63-88080, JP-A-2-17971, or JP-A-2-265672.

(3) Upper and lower layers are substantially simultaneously applied by means of an extrusion coating device with a backup roll, such as one disclosed in JP-A-2-174965.

The thickness of the magnetic layer of the magnetic recording medium of the present invention is optimized according to the head saturation magnetization, the head gap, and the bandwidth of the recording signal, and is generally 0.01 to 0.10 μm, preferably 0.02 to 0.08 μm, and more preferably 0.03 to 0.08 μm. The magnetic layer can be divided into two or more layers having different magnetic properties, and the configuration of a known multilayer magnetic layer can be employed.

When a non-magnetic layer is provided in the present invention, the thickness thereof is preferably 0.2 to 3.0 μm, more preferably 0.3 to 2.5 μm, and yet more preferably 0.4 to 2.0 μm. The non-magnetic layer of the magnetic recording medium of the present invention exhibits its effect as long as it is substantially non-magnetic, but even if it contains a small amount of a magnetic substance as an impurity or intentionally, if the effects of the present invention are exhibited, the constitution can be considered to be substantially the same as that of the magnetic recording medium of the present invention. ‘Substantially the same’ referred to here means that the non-magnetic layer has a residual magnetic flux density of 10 mT (100 G) or less or a coercive force of 7.96 kA/m (100 Oe) or less, and preferably has no residual magnetic flux density and no coercive force.

The silane-modified polyurethane resin may be used as all or part of the binder of the non-magnetic layer. It is preferable to use it as all of the binder of the non-magnetic layer.

In the present invention, it is preferable to provide the lower layer containing the inorganic powder on the support in order to apply the magnetic layer stably, and to apply the magnetic layer by a wet-on-wet method.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a ferromagnetic metal powder, in general, in-plane two-dimensional random is preferable, but it can be three-dimensional random by introducing a vertical component. In the case of a ferromagnetic hexagonal ferrite powder, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 m/min to 1,000 m/min and the temperature of drying air to be 60° C. or higher, and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to treat with metal rolls.

The magnetic recording medium of the present invention preferably has a surface center line average roughness in the range of 0.1 to 4 nm for a cutoff value of 0.25 mm, and more preferably 1 to 3 nm, which is extremely smooth. As a method therefor, a magnetic layer formed by selecting a specific ferromagnetic powder and binder as described above is subjected to the above-mentioned calendering treatment.

The calender roll temperature is preferably in the range of 60° C. to 100° C., more preferably in the range of 70° C. to 100° C., and yet more preferably in the range of 80° C. to 100° C. The calender roll pressure is preferably in the range of 100 to 500 kg/cm, more preferably in the range of 200 to 450 kg/cm, and yet more preferably in the range of 300 to 400 kg/cm. The magnetic recording medium thus obtained can be cut to a desired size using a cutter, etc. before use.

By carrying out kneading and dispersion using the polyurethane resin of the present invention, adsorption of the binder onto the magnetic material is increased, and the magnetic layer smoothness and the electromagnetic conversion characteristics are improved. Moreover, the transport durability is improved and head contamination due to repetitive transport is suppressed.

### EXAMPLES

The present invention is explained in detail below with reference to Examples, but these Examples should not be construed as limiting the present invention. In the explanation below, ‘parts’ means ‘parts by weight’ unless otherwise specified.

Measurement Methods

Measurement methods for magnetic recording media formed in the Examples were as follows.

1. Binder Adsorption

A magnetic coating solution was centrifuged, the solids content of the supernatant was measured, and the proportion of adsorbed components was determined.

2. Coating Smoothness

The center line average surface roughness Ra for a cutoff value of 0.25 mm was obtained by an optical interference method using a digital optical profiler (manufactured by WYKO). The coating smoothness of the Examples was expressed as a value relative to 10.0 for the value of Comparative Example 1.

3. Electromagnetic Conversion Characteristics

A single frequency signal at 4.7 MHz was recorded using a DDS3 drive at an optimum recording current, and the playback output was measured. The playback output of the Examples was expressed as a value relative to 0 dB for the playback output of Comparative Example 1.

4. Head Contamination after Transport

The head contamination was inspected after repeating 100 passes of 60 minutes length in the above drive at 23° C. and 10% RH; when there was contamination, the result was evaluated as B, and when there was no contamination the result was evaluated as A.

### Synthetic Example of Polyester Polyol

A reactor equipped with a thermometer, a stirrer, and a reflux condenser was charged with adipic acid and neopentyl glycol and, as catalysts, zinc acetate (2 wt %) and sodium acetate (3 wt %), an esterification reaction was carried out at 180° C. to 220° C. for 3 hours, and a polycondensation reaction was carried out at 220° C. to 280° C. under a reduced pressure of 1 to 10 mmHg for 2 hours. The amounts of adipic acid and neopentyl glycol charged were as shown in Table 1. A polyester polyol was thus obtained.

### Synthetic Example of Polyurethane with Branched OH Introduced

The polyurethane starting materials shown in Table 1 were used. A diol, a diisocyanate, and the trifunctional hydroxy compound TMP (trimethylol propane) as part of the chain extending agent, which are shown in Table 1, were used to give by polymerization a polyurethane having three or more branched OH groups per molecule introduced by branching the terminals.

The polymerization reaction for obtaining the polyurethane was carried out as follows. A reactor equipped with a reflux condenser and a stirrer was flushed with nitrogen and then charged with a polyol and a chain extending agent, which were dissolved in cyclohexanone to give a 30% solution under a flow of nitrogen at 60° C. Dibutyltin dilaurate (60 ppm) was subsequently added thereto as a catalyst and dissolved for a further 15 minutes. A polyol, a chain extending agent, and a diisocyanate were added, and a reaction was carried out by heating at 90° C. for 6 hours to give a solution of a polyurethane resin (PU1 to 4, solution concentration 30 wt %) into which a branched OH had been introduced.

The materials used for preparation of the polyurethane resin solutions PU1 to 4 and characteristic properties of the polyurethanes obtained are given in Table 1.

TABLE 1

| | Polyol | | | | | | | | | | | | | | |
|---|---|---|---|---|---|---|---|---|---|---|---|---|---|---|---|
| | | | Molecu- | | | | | | | | | OH group | | | |
| Polyu- | | Molar | lar | Chain extending agent | | | | | | Diisocyanate | | (μeq/ | | | |
| rethane | Type | ratio | weight | Amount | Diol | Amount | Triol | Amount | DEIS | Type | Amount | g) | (/molecule) | Mw | Mn |
| PU1 | ApA/NPG | 1.00/1.05 | 520 | 41 | DMH | 3 | TMP | 8 | 3 | MDI | 45 | 309 | 6.5 | 41000 | 21000 |
| PU2 | ApA/NPG | 1.00/1.05 | 520 | 38 | DMH | 3 | TMP | 10 | 3 | MDI | 46 | 560 | 12.3 | 42000 | 22000 |
| PU3 | ApA/NPG | 1.00/1.05 | 520 | 45 | DMH | 3 | TMP | 6 | 3 | MDI | 43 | 175 | 3.7 | 43000 | 21000 |
| PU4 | ApA/NPG | 1.00/1.05 | 520 | 46 | DMH | 11 | TMP | 0 | 3 | MDI | 40 | 111 | 2.2 | 40000 | 20000 |

ApA: Adipic acid
NPG: Neopentylglycol (2,2-dimethyl-1,3-propanediol)
DMH: Dimethylolheptane (2-ethyl-2-butyl-1,3-propanediol)
TMP: Trimethyolpropane (2-ethyl-2-hydroxylmethyl-1,3-dipropanediol)
DIES: Ethyleneoxide adduct of sulfoisophthalic acid
MDI: 4,4-Diphenylmethane diisocyanate

Amount expressed as parts by weight.

### Synthetic Example of Silane-Modified Polyurethane (Si-PU-I)

The hydrolyzable alkoxysilanes shown in Table 2 were added to the above-mentioned polyurethane solutions (PU1 to 4), and addition reactions were carried out at 90° C. for 5 hours while stirring well to give silane-modified polyurethane resin solutions (Si—PU1 to 12, solution concentration 30 wt %).

The materials used for preparation of the silane-modified polyurethane resin solutions are given in Table 2.

TABLE 2

| Silane | | | | | | | | | Alkoxy group after alcohol | |
|---|---|---|---|---|---|---|---|---|---|---|
| modified | | | | | | | | Proportion | removal reaction | |
| poly- | | Hydrolyzable alkoxysilane (b) | | | | | | added | Amount | |
| urethane | PU(a) | Type | Structure | n | R | X1 | X2 | (*) | (/molecule) | Form |
| Si-PU1 | PU1 | Tetramethoxysilane | (1) | 1 | Methyl group | — | — | 1.0 | 19.5 | Terminal & |
| | | | | | (C1) | | | | | main chain |
| Si-PU2 | PU1 | Tetraethoxysilane | (1) | 1 | Ethyl group | — | — | 1.0 | 19.5 | Terminal & |
| | | | | | (C2) | | | | | main chain |
| Si-PU3 | PU1 | Tetrabutoxysilane | (1) | 1 | Butyl group | — | — | 1.0 | 19.5 | Terminal & |
| | | | | | (C4) | | | | | main chain |
| Si-PU4 | PU1 | Tetramethoxysilane | (1) | 4 | Methyl group | — | — | 1.0 | 58.5 | Terminal & |
| | | partial condensate | | | (C1) | | | | main chain | |
| Si-PU5 | PU1 | Tetraethoxysilane | (1) | 5 | Ethyl group | — | — | 1.0 | 71.5 | Terminal & |
| | | partial condensate | | | (C2) | | | | | main chain |
| Si-PU6 | PU1 | Methyltrimethoxysilane | (2) | 1 | Methyl group | Methyl | Methoxy | 1.0 | 13.0 | Terminal & |
| | | | | | (C1) | group | group | | | main chain |
| Si-PU7 | PU1 | Dimethyldimethoxysilane | (2) | 1 | Methyl group | Methyl | Methyl | 1.0 | 6.5 | Terminal & |
| | | | | | (C1) | group | group | | | main chain |
| Si-PU8 | PU1 | Tetramethoxysilane | (1) | 1 | Methyl group | — | +113 | 0.5 | 9.8 | Terminal & |
| | | | | | (C1) | | | | | main chain |
| Si-PU9 | PU1 | Tetramethoxysilane | (1) | 1 | Methyl group | — | — | 3.0 | 19.5 | Terminal & |
| | | | | | (C1) | | | | | main chain |
| Si-PU10 | PU2 | Tetramethoxysilane | (1) | 1 | Methyl group | — | — | 1.0 | 36.9 | Terminal & |
| | | | | | (C1) | | | | | main chain |
| Si-PU11 | PU3 | Tetramethoxysilane | (1) | 1 | Methyl group | — | — | 1.0 | 11.1 | Terminal & |
| | | | | | (C1) | | | | | main chain |
| Si-PU12 | PU4 | Tetramethoxysilane | (1) | 1 | Methyl group | — | — | 1.0 | 6.6 | Terminal |
| | | | | | (C1) | | | | | only |

(*) (number of moles of b)/(equivalent weight of OH groups in PU)

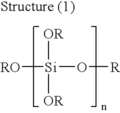

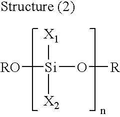

### Example 1

Preparation of upper layer magnetic coating solution

| | |
|---|---|
| Ferromagnetic acicular metal powder | 100 parts |
| (composition: Fe/Co/Al/Y = 62/25/5/8; surface treatment | |
| agent: Al₂O₃, Y₂O₃; Hc 167 kA/m (2,100 Oe); crystallite | |
| size 110 Å; major axis length 60 nm; acicular ratio 6; | |
| BET specific surface area 70 m²/g; σs 110 A·m²/kg | |
| (emu/g)) | |
| silane-modified polyurethane resin solution Si-PU1 | 50 parts |
| (shown in Table 3) | |
| phenyl phosphate | 3 parts |
| α-Al₂O₃ (particle size 0.15 μm) | 2 parts, and |
| carbon black (particle size 20 nm) | 2 parts |
| were kneaded in an open kneader for 60 minutes, then | |
| cyclohexanone | 110 parts |
| methyl ethyl ketone | 100 parts |
| toluene | 100 parts |
| butyl stearate | 2 parts, and |
| stearic acid | 1 part |
| were added thereto and dispersed in a sand mill for 120 | |
| minutes. To the dispersion thus obtained was added | |
| trifunctional low molecular weight polyisocyanate | 6 parts |
| compound | |

(Coronate 3041, manufactured by Nippon Polyurethane Industry Co., Ltd.), and the mixture was stirred for a further 20 minutes and filtered using a filter having an average pore size of 1 μm to give a magnetic coating solution.

Preparation of lower layer non-magnetic coating solution

| | |
|---|---|
| As non-magnetic inorganic powders, | 85 parts |
| α-iron oxide | |
| (surface treatment agent: Al₂O₃, SiO₂; major axis | |
| length 0.15 μm; tap density 0.8; acicular ratio 7; BET | |
| specific surface area 52 m²/g; pH 8; DBP oil absorption | |
| 33 g/100 g) and | |
| carbon black | 20 parts |
| (DBP oil absorption 120 mL/100 g, pH 8, BET specific | |
| surface area 250 m²/g, volatile content 1.5%), | |
| polyurethane resin solution PU1 | 15 parts |
| phenyl phosphate | 3 parts, and |
| α-Al₂O₃ (average particle size 0.2 μm) | 1 part |
| were kneaded in an open kneader for 60 minutes, then | |
| cyclohexanone | 140 parts |
| methyl ethyl ketone | 170 parts |
| butyl stearate | 2 parts, and |
| stearic acid | 1 part |
| were added thereto and dispersed in a sand mill for 120 | |
| minutes. To the dispersion thus obtained was added | |
| trifunctional low molecular weight polyisocyanate | 6 parts |
| compound | |

(Coronate 3041, manufactured by Nippon Polyurethane Industry Co., Ltd.), and the mixture was stirred for a further 20 minutes and filtered using a filter having an average pore size of 1 μm to give a non-magnetic coating solution.

A 6 μm thick PEN base was subjected to simultaneous multilayer coating with the lower layer non-magnetic coating solution, which was applied so that the dry thickness would be 1.8 μm, followed immediately by the upper layer magnetic coating solution, which was applied so that the dry thickness would be 0.08 μm. Before the two layers had dried, magnetic field alignment was carried out using a 3,000 gauss magnet; after drying, a surface smoothing treatment employing a 7 stage calender consisting of metal rolls alone at a speed of 100 m/min, a line pressure of 300 kg/cm and a temperature of 90° C., and a thermal curing treatment at 70° C. for 24 hours were carried out, followed by slitting to a width of 6.35 mm to give a magnetic tape.

### Examples 2 to 12 and Comparative Example 1

The procedure of Example 1 was repeated except that the silane-modified polyurethane resin Si—PU1 used in the upper layer magnetic coating solution in Example 1 was changed to the silane-modified polyurethanes or the non-silane-modified polyurethane shown in Table 3, thus preparing magnetic recording media.

The materials used for the magnetic recording media prepared in Examples 2 to 12 and Comparative Example 1 and the results obtained by measuring various characteristic properties are given in Table 3.

TABLE 3

| | | | | Pro- | Alkoxy group after alcohol | | Adsorption | | Electro- | Head |
|---|---|---|---|---|---|---|---|---|---|---|
| | Mag- | | Hydrolyzable | portion | removal reaction | | mg/g of | Smoothness | magnetic | contamina- |
| | netic | Poly- | alkoxysilane (b) | added | Amount | | magnetic | of | conversion | tion after |
| | material | urethane | Type | (*) | (/molecule) | Form | material | coating | char. dB | transport |
| Ex. 1 | MP1 | Si-PU1 | Tetramethoxysilane | 1.0 | 11.7 | Terminal & | 98 | 6.8 | 2.1 | A |
| | | | | | | main chain | | | | |
| Ex. 2 | MP1 | Si-PU2 | Tetraethoxylsilane | 1.0 | 11.7 | Terminal & | 95 | 7.2 | 2.0 | A |
| | | | | | | main chain | | | | |
| Ex. 3 | MP1 | Si-PU3 | Tetrabutoxylsilane | 1.0 | 11.7 | Terminal & | 92 | 7.6 | 1.8 | A |
| | | | | | | main chain | | | | |
| Ex. 4 | MP1 | Si-PU4 | Tetramethoxysilane | 1.0 | 35.1 | Terminal & | 103 | 7.0 | 2.2 | A |
| | | | partial condensate | | | main chain | | | | |
| Ex. 5 | MP1 | Si-PU5 | Tetraethoxylsilane | 1.0 | 42.9 | Terminal & | 100 | 6.9 | 2.1 | A |
| | | | partial condensate | | | main chain | | | | |
| Ex. 6 | MP1 | Si-PU6 | Methyltrimethoxysilane | 1.0 | 7.8 | Terminal & | 91 | 7.6 | 1.9 | A |
| | | | | | | main chain | | | | |
| Ex. 7 | MP1 | Si-PU7 | Dimethyldimethoxysilane | 1.0 | 3.9 | Terminal & | 89 | 7.5 | 1.8 | A |
| | | | | | | main chain | | | | |
| Ex. 8 | MP1 | Si-PU8 | Tetramethoxysilane | 0.5 | 5.9 | Terminal & | 85 | 7.3 | 1.6 | A |
| | | | | | | main chain | | | | |
| Ex. 9 | MP1 | Si-PU9 | Tetramethoxysilane | 3.0 | 11.7 | Terminal & | 89 | 7.8 | 1.6 | A |
| | | | | | | main chain | | | | |
| Ex. 10 | MP1 | Si-PU10 | Tetramethoxysilane | 1.0 | 21.9 | Terminal & | 110 | 6.6 | 2.4 | A |
| | | | | | | main chain | | | | |
| Ex. 11 | MP1 | Si-PU11 | Tetramethoxysilane | 1.0 | 9.0 | Terminal & | 92 | 7.5 | 1.8 | A |
| | | | | | | main chain | | | | |
| Ex. 12 | MP1 | Si-PU12 | Tetramethoxysilane | 1.0 | 6.3 | Terminal | 85 | 7.4 | 1.7 | A |
| | | | | | | only | | | | |
| Comp. | MP1 | PU-1 | — | — | — | — | 60 | 10.0 | 0.0 | B |
| Ex. 1 | | | | | | | | | | |

MP1: Ferromagnetic acicular metal powder
(*) (number of moles of b)/(equivalent weight of OH groups in PU)

### Examples 13 to 24 and Comparative Example 2

Examples 13 to 24 and Comparative Example 2 were carried out in the same manner as in Examples 1 to 12 and Comparative Example 1 respectively except that the 100 parts of magnetic material (ferromagnetic acicular metal powder) for the upper layer magnetic coating solution used in Example 1 was changed to
ferromagnetic tabular hexagonal ferrite powder 100 parts
composition (molar ratio): Ba/Fe/Co/Zn=1/9/0.2/1,
Hc: 2,000 Oe, plate size: 25 nm, tabular ratio: 3,
BET specific surface area: 80 m²/g, σs: 50 A·m²/kg (emu/g).

The materials used for magnetic recording media prepared in Examples 13 to 24 and Comparative Example 2 and the results obtained by measuring various characteristic properties are given in Table 4.

TABLE 4

| | | | | Pro- | Alkoxy group after alcohol | | Adsorption | | Electro- | Head |
|---|---|---|---|---|---|---|---|---|---|---|
| | Mag- | | Hydrolyzable | portion | removal reaction | | mg/g of | Smoothness | magnetic | contamina- |
| | netic | Poly- | alkoxysilane (b) | added | Amount | | magnetic | of | conversion | tion after |
| | material | urethane | Type | (*) | (/molecule) | Form | material | coating | char. dB | transport |
| Ex. 13 | BF1 | Si-PU1 | Tetramethoxysilane | 1.0 | 11.7 | Terminal & | 113 | 7.0 | 1.9 | A |
| | | | | | | main chain | | | | |
| Ex. 14 | BF1 | Si-PU2 | Tetraethoxylsilane | 1.0 | 11.7 | Terminal & | 109 | 7.4 | 1.8 | A |
| | | | | | | main chain | | | | |
| Ex. 15 | BF1 | Si-PU3 | Tetrabutoxylsilane | 1.0 | 11.7 | Terminal & | 106 | 7.8 | 1.6 | A |
| | | | | | | main chain | | | | |
| Ex. 16 | BF1 | Si-PU4 | Tetramethoxysilane | 1.0 | 35.1 | Terminal & | 118 | 7.2 | 2.0 | A |
| | | | partial condensate | | | main chain | | | | |
| Ex. 17 | BF1 | Si-PU5 | Tetraethoxylsilane | 1.0 | 42.9 | Terminal & | 115 | 7.1 | 1.9 | A |
| | | | partial condensate | | | main chain | | | | |
| Ex. 18 | BF1 | Si-PU6 | Methyltrimethoxysilane | 1.0 | 7.8 | Terminal & | 105 | 7.8 | 1.7 | A |
| | | | | | | main chain | | | | |
| Ex. 19 | BF1 | Si-PU7 | Dimethyldimethoxysilane | 1.0 | 3.9 | Terminal & | 102 | 7.7 | 1.6 | A |
| | | | | | | main chain | | | | |
| Ex. 20 | BF1 | Si-PU8 | Tetramethoxysilane | 0.5 | 5.9 | Terminal & | 98 | 7.5 | 1.4 | A |
| | | | | | | main chain | | | | |
| Ex. 21 | BF1 | Si-PU9 | Tetramethoxysilane | 3.0 | 11.7 | Terminal & | 102 | 8.0 | 1.4 | A |
| | | | | | | main chain | | | | |
| Ex. 22 | BF1 | Si-PU10 | Tetramethoxysilane | 1.0 | 21.9 | Terminal & | 127 | 6.8 | 2.2 | A |
| | | | | | | main chain | | | | |
| Ex. 23 | BF1 | Si-PU11 | Tetramethoxysilane | 1.0 | 9.0 | Terminal & | 106 | 7.7 | 1.6 | A |
| | | | | | | main chain | | | | |
| Ex. 24 | BF1 | Si-PU12 | Tetramethoxysilane | 1.0 | 6.3 | Terminal | 98 | 7.4 | 1.7 | A |
| | | | | | | only | | | | |
| Comp. | BF1 | PU-1 | — | — | — | — | 62 | 10.0 | 0.0 | B |
| Ex. 2 | | | | | | | | | | |

BF1: Ferromagnetic tabular hexagonal ferrite powder
(*) (number of moles of b)/(equivalent weight of OH groups in PU)

### Examples 25 to 36

Magnetic recording media of Examples 25 to 36 were prepared in the same manner as in Examples 13 to 24 except that the silane-modified polyurethane resin solutions Si—PU1 to Si—PU12 were used instead of the polyurethane resin solution PU-1 of the lower layer non-magnetic coating solution used in Example 1.

The results obtained by measuring various characteristic properties were substantially the same as those shown in Table 4.

### Synthetic Example of Silane-Modified Polyurethane (Si-PU-II)

The silane coupling agents having an NCO group shown in Table 5 were added to the above-mentioned polyurethane solutions (PU1 to 4), and an alcohol removal reaction was carried out at 90° C. for 5 hours while stirring well to give silane-modified polyurethane resin solutions (Si—PU 13 to 19, solution concentration 30 wt %).

The materials used for preparation of the silane-modified polyurethane resin solutions are given in Table 5.

TABLE 5

| | | | | | | Alkoxy group after addition | |
|---|---|---|---|---|---|---|---|
| | | | | | | reaction | |
| Silanemodified | | NCO-containing silane coupling agent (c) | | | Proportion | Amount | |
| polyurethane | PU(a) | Type | R₁ | R₂ | added(*) | (/molecule) | Form |
| Si-PU13 | PU1 | 3-Isocyanatopropyltrimethoxysilane | Methyl group | Propylene group | 1.0 | 19.5 | Terminal & |
| | | | (C1) | (C3) | | | main chain |
| Si-PU14 | PU1 | 3-Isocyanatopropyltriethoxysilane | Ethyl group | Propylene group | 1.0 | 19.5 | Terminal & |
| | | | (C2) | (C3) | | | main chain |
| Si-PU15 | PU1 | 3-Isocyanatopropyltrimethoxysilane | Methyl group | Propylene group | 0.5 | 9.8 | terminal & |
| | | | (C1) | (C3) | | | main chain |
| Si-PU16 | PU1 | 3-Isocyanatopropyltrimethoxysilane | Methyl group | Propylene group | 3.0 | 19.5 | Terminal & |
| | | | (C1) | (C3) | | | main chain |
| Si-PU17 | PU2 | 3-Isocyanatopropyltrimethoxysilane | Methyl group | Propylene group | 1.0 | 36.9 | Terminal & |
| | | | (C1) | (C3) | | | main chain |
| Si-PU18 | PU3 | 3-Isocyanatopropyltrimethoxysilane | Methyl group | Propylene group | 1.0 | 11.1 | Terminal & |
| | | | (C1) | (C3) | | | main chain |
| Si-PU19 | PU4 | 3-Isocyanatopropyltrimethoxysilane | Methyl group | Propylene group | 1.0 | 6.6 | Terminal |
| | | | (C1) | (C3) | | | only |

(*) (number of moles of c)/(equivalent weight of OH groups in PU)

(R₁O)₃—Si—R₂—NCO

### Examples 37 to 43

The procedure of Example 1 was repeated except that the silane-modified polyurethane resin (Si—PU1) used in the upper layer magnetic coating solution in Example 1 was changed to the silane-modified polyurethanes shown in Table 6, thus preparing magnetic recording media of Examples 37 to 43.

The materials used for the magnetic recording media prepared in Examples 37 to 43 and the results obtained by measuring various characteristic properties are given in Table 6 together with the results for Comparative Example 1.

TABLE 6

| | | | | Pro- | | | Ad- | | | |
|---|---|---|---|---|---|---|---|---|---|---|
| | Mag- | | NCO-containing | por- | Alkoxy group after addition | | sorption | Smooth- | Electro- | Head con- |
| | netic | | silane coupling | tion | reaction | | mg/g of | ness | magnetic | tamina- |
| | ma- | Poly- | agent (c) | added | Amount | | magnetic | of | conversion | tion after |
| | terial | urethane | Type | (*) | (/molecule) | Form | material | coating | Char. dB | transport |
| Ex. 37 | MP1 | Si-PU13 | 3-Isocyanatopropyltrimethoxysilane | 1.0 | 19.5 | Terminal & | 96 | 7.0 | 1.9 | A |
| | | | | | | main chain | | | | |
| Ex. 38 | MP1 | Si-PU14 | 3-Isocyanatopropyltriethoxysilane | 1.0 | 19.5 | Terminal & | 93 | 7.4 | 1.8 | A |
| | | | | | | main chain | | | | |
| Ex. 39 | MP1 | Si-PU15 | 3-Isocyanatopropyltrimethoxysilane | 0.5 | 9.8 | Terminal & | 83 | 7.5 | 1.4 | A |
| | | | | | | main chain | | | | |
| Ex. 40 | MP1 | Si-PU16 | 3-Isocyanatopropyltrimethoxysilane | 3.0 | 19.5 | Terminal & | 87 | 8.0 | 1.4 | A |
| | | | | | | main chain | | | | |
| Ex. 41 | MP1 | Si-PU17 | 3-Isocyanatopropyltrimethoxysilane | 1.0 | 36.9 | Terminal & | 108 | 6.8 | 2.2 | A |
| | | | | | | main chain | | | | |
| Ex. 42 | MP1 | Si-PU18 | 3-Isocyanatopropyltrimethoxysilane | 1.0 | 11.1 | Terminal & | 90 | 7.7 | 1.6 | A |
| | | | | | | main chain | | | | |
| Ex. 43 | MP1 | Si-PU19 | 3-Isocyanatopropyltrimethoxysilane | 1.0 | 6.6 | Terminal | 80 | 7.2 | 1.4 | A |
| | | | | | | only | | | | |
| Comp. | MP1 | PU-1 | — | — | — | — | 60 | 10.0 | 0.0 | B |
| Ex. 1 | | | | | | | | | | |

*MP1: Ferromagnetic acicular metal powder
(*) (number of moles of c)/(equivalent weight of OH groups in PU)

### Examples 44 to 50

Examples 44 to 50 were carried out in the same manner as in Examples 37 to 43 respectively except that the 100 parts of magnetic material (ferromagnetic acicular metal powder) for the upper layer magnetic coating solution used in Example 37 was changed to
ferromagnetic tabular hexagonal ferrite powder 100 parts
composition (molar ratio): Ba/Fe/Co/Zn=1/9/0.2/1,
Hc: 2,000 Oe, plate size: 25 nm, tabular ratio: 3,
BET specific surface area: 80 m²/g, σs: 50 A·m²/kg (emu/g).

The materials used for the magnetic recording media prepared in Examples 44 to 50 and the results obtained by measuring various characteristic properties are given in Table 7 together with the results for Comparative Example 2.

TABLE 7

| | | | | Pro- | | | Ad- | | | |
|---|---|---|---|---|---|---|---|---|---|---|
| | Mag- | | NCO-containing | por- | Alkoxy group after addition | | sorption | Smooth- | Electro- | Head con- |
| | netic | | silane coupling | tion | reaction | | mg/g of | ness | magnetic | tamina- |
| | ma- | Poly- | agent (c) | added | Amount | | magnetic | of | conversion | tion after |
| | terial | urethane | Type | (*) | (/molecule) | Form | material | coating | char. dB | transport |
| Ex. 44 | BF1 | Si-PU13 | 3-Isocyanatopropyltrimethoxysilane | 1.0 | 19.5 | Terminal & | 110 | 7.2 | 1.7 | A |
| | | | | | | main chain | | | | |
| Ex. 45 | BF1 | Si-PU14 | 3- Isocyanatopropyltriethoxysilane | 1.0 | 19.5 | Terminal & | 107 | 7.6 | 1.6 | A |
| | | | | | | main chain | | | | |
| Ex. 46 | BF1 | Si-PU15 | 3-Isocyanatopropyltrimethoxysilane | 0.5 | 9.8 | Terminal & | 95 | 7.7 | 1.2 | A |
| | | | | | | main chain | | | | |
| Ex. 47 | BF1 | Si-PU16 | 3-Isocyanatopropyltrimethoxysilane | 3.0 | 19.5 | Terminal & | 100 | 8.2 | 1.2 | A |
| | | | | | | main chain | | | | |
| Ex. 48 | BF1 | Si-PU17 | 3-Isocyanatopropyltrimethoxysilane | 1.0 | 36.9 | Terminal & | 124 | 7.0 | 2.0 | A |
| | | | | | | main chain | | | | |
| Ex. 49 | BF1 | Si-PU18 | 3-Isocyanatopropyltrimethoxysilane | 1.0 | 11.1 | Terminal & | 104 | 7.9 | 1.4 | A |
| | | | | | | main chain | | | | |
| Ex. 50 | BF1 | Si-PU19 | 3-Isocyanatopropyltrimethoxysilane | 1.0 | 6.6 | Terminal | 84 | 7.8 | 1.0 | A |
| | | | | | | only | | | | |
| Comp. | BF1 | PU-1 | — | — | — | — | 62 | 10.0 | 0.0 | B |
| Ex. 2 | | | | | | | | | | |

*BF1: Ferromagnetic tabular hexagonal ferrite powder
(*) (number of moles of c)/(equivalent weight of OH groups in PU)

### Examples 51 to 57

Magnetic recording media of Examples 51 to 57 were prepared in the same manner as in Examples 44 to 50 except that the silane-modified polyurethane resin solutions Si—PU13 to Si—PU19 were used instead of the polyurethane resin solution PU-1 of the lower layer non-magnetic coating solution used in Example 37.

The results obtained by measuring various characteristic properties were substantially the same as those shown in Table 7.

1. A magnetic recording medium comprising, above a non-magnetic support, at least one magnetic layer comprising a ferromagnetic powder dispersed in a binder, the magnetic recording medium comprising:
a first silane-modified polyurethane resin (Si-PU-I) obtained by a reaction between a polyurethane (a) having a hydroxyl group in the molecule and a hydrolyzable alkoxysilane (b), or
a second silane-modified polyurethane resin (Si-PU-II) obtained by a reaction between the polyurethane (a) having a hydroxyl group in the molecule and an alkoxysilane (c) having an isocyanato group.

2. The magnetic recording medium according to claim 1, wherein the hydrolyzable alkoxysilane (b) is a tetraalkoxysilane and/or a condensate thereof represented by Formula (1) below 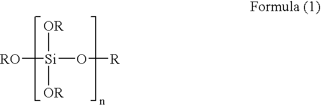
(in the formula, R denotes a straight-chain or branched-chain lower alkyl group having six or fewer carbons, n denotes an integer of 1 to 10, and two or more of R may be identical to or different from each other).

3. The magnetic recording medium according to claim 1, wherein the hydrolyzable alkoxysilane (b) is a tetraalkoxysilane and/or a condensate thereof represented by Formula (1) below 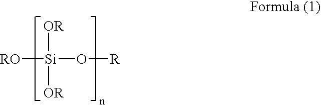
(in the formula, R denotes a methyl group or an ethyl group, n denotes an integer of 1 to 5, and two or more of R may be identical to or different from each other).

4. The magnetic recording medium according to claim 1, wherein the hydrolyzable alkoxysilane (b) is a trialkoxysilane, a dialkoxysilane, and/or a condensate thereof represented by Formula (2) below, or a mixture thereof 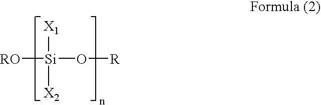
(in the formula, X₁ denotes OR, a straight-chain or branched-chain lower alkyl group having six or fewer carbons, or a phenyl group, X₂ denotes a straight-chain or branched-chain lower alkyl group having six or fewer carbons or a phenyl group, R denotes a straight-chain or branched-chain lower alkyl group having six or fewer carbons, two or more of R may be identical to or different from each other, and n denotes an integer of 1 to 10).

5. The magnetic recording medium according to claim 1, wherein the hydrolyzable alkoxysilane (b) is a trialkoxysilane, a dialkoxysilane, and/or a condensate thereof represented by Formula (2) below, or a mixture thereof 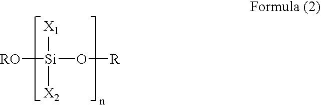
(in the formula, X₁ denotes OR, a methyl group, or an ethyl group, X₂ and R denote a methyl group or an ethyl group, two or more of R may be identical to or different from each other, and n denotes an integer of 1 to 5).

6. The magnetic recording medium according to claim 1, wherein the alkoxysilane (c) having an isocyanato group is a trialkoxysilane represented by Formula (3) below
(R₁O)₃—Si—R₂—NCO Formula (3)
(in the formula, R₁ denotes a straight-chain or branched-chain lower alkyl group having six or fewer carbons, and R₂ denotes a straight-chain or branched-chain lower alkylene group having six or fewer carbons).

7. The magnetic recording medium according to claim 1, wherein the alkoxysilane (c) having an isocyanato group is a trialkoxysilane represented by Formula (3) below
(R₁O)₃—Si—R₂—NCO Formula (3)
(in the formula, R₁ denotes a methyl group or an ethyl group, and R₂ denotes a propylene group).

8. The magnetic recording medium according to claim 1, wherein the polyurethane (a) having a hydroxyl group in the molecule has at least three hydroxyl groups per molecule.

9. The magnetic recording medium according to claim 1, wherein the polyurethane (a) having a hydroxyl group in the molecule is a polyurethane resin obtained by a reaction of a long chain diol, a short chain diol, and a diisocyanate compound.

10. The magnetic recording medium according to claim 9, wherein the polyurethane (a) having a hydroxyl group in the molecule has a long chain diol/short chain diol/diisocyanate composition of (15 to 80 wt %)/(5 to 40 wt %)/(15 to 50 wt %).

11. The magnetic recording medium according to claim 1, wherein the polyurethane (a) having a hydroxyl group in the molecule contains a polar group selected from the group consisting of —SO₃M, —SO₄M, —PO(OM)₂, —OPO(OM)₂, —COOM, >NSO₃M, —NR¹SO₃M, —NR¹R², and —N⁺R¹R²R³X⁻ (M denotes a hydrogen atom, an alkali metal, or an ammonium salt, R¹, R², and R³ independently denote a hydrogen atom or an alkyl group having 1 to 10 carbons, and X denotes a monovalent halide ion).

12. The magnetic recording medium according to claim 1, wherein it further comprises, between the non-magnetic support and the magnetic layer, a non-magnetic layer comprising a non-magnetic powder dispersed in a binder.

13. The magnetic recording medium according to claim 1, wherein the first silane-modified polyurethane resin Si-PU-I and/or the second silane-modified polyurethane resin Si-PU-II are contained in the magnetic layer and/or the non-magnetic layer.

14. The magnetic recording medium according to claim 1, wherein the ferromagnetic powder is a ferromagnetic metal powder.

15. The magnetic recording medium according to claim 1, wherein the ferromagnetic powder is a ferromagnetic hexagonal ferrite powder.
